(19) United States
(12) Patent Application Publication
(10) Pub. No.: US 2004/0049622 A1
(43) Pub. Date: Mar. 11, 2004

(54) Programming tool

(75) Inventor: Thilo Opaterny, Nuemberg (DE)

Correspondence Address: SUGHRUE MION, PLLC, 2100 Pennsylvania Avenue, NW, Washington, DC, 20037-3213, US

(73) Assignee: Siemens Aktiengesellschaft

(21) Appl. No.: 10/428,045

(22) Filed: May 2, 2003

Related U.S. Application Data
(63) Continuation of application No. PCT/DE01/04068, filed on Oct. 26, 2001.

(30) Foreign Application Priority Data
Nov. 2, 2000 (DE) 10054196.8

(51) Int. Cl. G06F 9/44

(52) U.S. Cl. 710/268; 712/233

(57) ABSTRACT

User programs composed of modules for use in automation systems may be created in a cyclic programming process. When solutions are created for complex automation tasks, there is a danger that during the execution of program sequences, individual operands can assume unexpected values in an unforeseen manner, causing error responses in the automation system. The method and programming tool allow data breakpoints to be set up within program logic that in particular has been graphically programmed, in the event of an occurrence of specific conditions. These data breakpoints are set up using a marker in an operand table, which contains selected operands coupled with the type and/or scope of the respective access operation, and using the unique definition of a specific access operation, (achieved by the marker), as a condition for the occurrence of the desired program interruption.

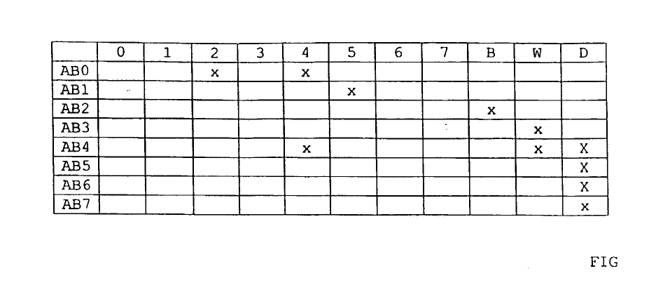

This is a Continuation of International Application PCT/DE01/04068, with an international filing date of Oct. 26, 2001, which was published under PCT Article 21(2) in German, and the disclosure of which is incorporated into this application by reference.

### FIELD OF AND BACKGROUND OF THE INVENTION

The invention relates to a programming tool for generating a program interrupt.

In automation systems, a program logic is used for the open loop and/or closed loop control of the sensors and/or actuators of a technical process. With such a program logic, the parameter values detected by the sensors and the values entered via operator control elements are read and further processed with internally determined or existing states or values to provide output values to the aforementioned sensors and/or actuators. In modern automation systems, the portion of the system provided by software continually increases.

Creating such a program logic for an automation system is distinct from conventional programs especially in that automation systems are typically cybernetic systems that run continuously with automatic open loop and/or closed loop control. This application requires constant repetition of continuously recurring sequences, which are open loop controlled and/or closed loop controlled by correspondingly recurring program sequences of the program logic. The programming technique required for this purpose is therefore referred to as cyclic programming. An important goal within cyclic programming is to achieve the shortest possible run time, since the run time of the individual program sequences essentially corresponds to the response time of the open loop and/or closed loop control underlying the open loop controlled and/or closed loop controlled system.

Prior to programming, the programmer dissects the tasks that occur within the context of the open loop and/or closed loop control of an automation system, in order to obtain individual tasks that can be mapped to the programming language used. In the context of this preparation, an attempt is made to identify as many constantly repeated tasks and modules as possible. Identifying constantly repeated partial sequences allows the programming to be especially clear and concise.

Application programs which conventionally consist of modules are widely used. These modules consist of networks, which in turn consist of operations that combine different operands. Graphic programming languages, such as ladder diagram (LAD) or sequential function chart (SFC), are available to create corresponding application programs. Within these programs, the modules represent networks of logic operations composed of operators and operands. In terms of textual programming languages, such as C or P ascal, such a module thus corresponds to a procedure or function. Each module has an interface and can be called by other modules. After one module has been executed, the module called next in the program logic is executed. A programming apparatus for formulating application programs is known, for instance, from German Laid-Open Publication DE 197 28 476 A1, the disclosure of which is incorporated herein by reference.

Even with the greatest care, it is unavoidable that, as the program is executed, individual operands will suddenly have a different value than originally expected. At that point, the program will thus not respond as expected. This is the case, for the most part—especially in complex processes—if input values not previously considered or expected have acted on the preceding module.

So-called interrupts are familiar in connection with textual programming languages as well as in the hardware area. These are interruptions of an ongoing process by the CPU if a corresponding condition is met. A distinction is drawn between hardware and software interrupts depending on whether the condition originates in the hardware or the software. To process the hardware interrupts, most processors have a separate interrupt controller. Software interrupts are triggered by special machine code instructions, or by the processor itself, if defined error conditions occur. Such interrupts make it possible to stop a process if certain conditions occur, in order to check what conditions caused the “STOP.” In connection with textual programming languages, such interrupts can be deliberately used to bring about an interruption as soon as a parameter assumes an unexpected value. Once the process has been interrupted, the conditions that led to the unexpected or undesirable state can be analyzed. Since, in the field of automation technology, the aforementioned modules can also call one another, the program listing obtained after a program has been completely executed is typically so complex that searching for the concrete cause of the error is very difficult.

### OBJECTS OF THE INVENTION

Thus, one object of the invention is to provide a method and a programming tool for generating a program interrupt that is used in conjunction with a program logic for the open loop and/or closed loop control of a technical process, in particular in conjunction with one of the graphic programming languages used in automation technology.

### SUMMARY OF THE INVENTION

According to one formulation, the invention is directed to a method for generating a corresponding program interrupt within a program logic with operators and operands for open loop and/or closed loop control of a technical process. A list generated during the translation of the program and containing operand identifiers and the locations where these operand identifiers are used is summarized into an identifier list. From this relatively extensive identifier list, an operand table is compiled with selected operands and identification of the respective access operations to these operands. Furthermore, this table can then be used to define specific access operations as a condition for the occurrence of a program interrupt.

Using this method, it is thus no longer necessary to review all the locations where the “problematic” operand was used in order to establish a program interrupt. Instead, the access type, which has either caused an error that must be checked or which has to be checked by way of a program interrupt for other reasons, can now be selected with ease.

The identifier list is typically generated in the translation of the program logic being analyzed. Until now, however, it has not been available for further processing. In an advantageous embodiment of the invention, all the partial identifier lists generated in the context of the individual translation runs are combined into a single, complete identifier list, which is then available for further processing, in this particular case for generating a program interrupt.

This identifier list has a filter element assigned to it which can be used to make the typically very extensive identifier list more clear and concise. It is possible, for instance, to select only the operand identifiers that are transmitted at the inputs and outputs of a module. Thus, the filter element can be used to select the operands that are relevant in connection with the definition of an interface.

Finally, it is possible within an operand table to mark a line, or one or more cells of this line, by means of a special marking tool. This selection uniquely determines the scope of the access to the selected operand and defines it as a condition for the program interrupt.

In a further embodiment, it is possible not only to define the scope of the access to an operand but also the type of the access as a criterion for generating a data breakpoint.

If the scope of the access is defined by marking cells or lines in the operand table, then the type of the access can be conveniently defined by means of a selection menu from which a desired type of access is selected by a further marking tool.

A programming tool according to the invention thus enables the conditions for a program interrupt to be defined, i.e., the setting up of a data breakpoint, without a cumbersome analysis of all the locations where the operand of interest was used and combined with ease of operation and a consistently clear display.

As soon as the conditions for a program interrupt have been uniquely defined by means of the above-described method, the programming tool automatically generates a data breakpoint by incorporating an instruction into the program sequence of the content to be processed. As a result, when the previously defined conditions occur, an instruction to interrupt the program, i.e., an interrupt, is generated. The further processing of the program logic is thereby interrupted at least temporarily.

The programming tool further has a program editor that opens automatically if a corresponding program interrupt occurs, so that the program, and in particular the parameters that caused the program interrupt, can be analyzed. Within the program editor, the corresponding program sequence, or the corresponding module, can then be revised and possibly be provided with changed data breakpoints by means of the programming tool, to enable a renewed analysis of the program sequence that controls the automation system.

### BRIEF DESCRIPTION OF THE DRAWINGS

The method and programming tool according to the invention will now be described with reference to the operand table depicted in the drawing. It should be noted that the realization according to the exemplary embodiment is only one of many possible ways to implement the inventive method and/or programming tool.

### DETAILED DESCRIPTION OF THE PREFERRED EMBODIMENTS

The invention will now be explained in greater detail by means of an exemplary embodiment with reference to the single drawing figure. The drawing figure shows a table of selected operands used within a program logic.

The table of the operands used within a program logic—shown merely by way of example in the drawing—relates, e.g., to the operands of an output (A), with a byte address assignment of (AB0 to AB7). Each byte address is assigned one line in the operand table. The individual lines are divided into different columns identifying different scopes of access to the byte address assigned to the respective line. A distinction is drawn between bitwise access operations (0 to 7), bytewise access (B), wordwise access (W), and double word access (D).

The operands summarized in the table represent only a subquantity, selected by means of a filter, of all the operators used within the program logic. In the present example, the operators of interest are the operators of output A.

The table further shows several markings, in this case crosses. Instead of being marked by crosses, the individual cells or lines of the table could also be designated with color or highlighted in some other manner. These markings show how the operators used are accessed. In the present case, the table shows the scope of the access. This tabulated display represents a graphic translation of the access operations to selected operands.

The information shown in the table is obtained from a temporarily stored identifier list that includes all the operand identifiers and the locations where they are used within the program logic. The identifier list is generated during the translation of the program logic and is subsequently temporarily stored, as mentioned above. A filter element, e.g., the selection of the output or input of a module, is used to define and display specific operands in the operand table, together with the scope of the access operations, as explained above.

A specific access operation can be selected as a condition for a program interrupt by selecting one or more lines or cells with a marking tool, e.g., by positioning a cursor in the operand table. In connection with the marking, a user is offered a popup or pull-down menu, or both, to define, in addition, the type of access, i.e., write, read, or both.

This uniquely defines one or more access operations to a specific operand as a condition for a program interrupt. A programming tool then automatically generates the desired data breakpoint at the access location thus defined.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for generating a program interrupt within a program logic with operators and operands for controlling a technical process, comprising:
generating, during the translation of the program logic, an identifier list of identifiers of the operands used within the program logic and of corresponding locations where the operands are used within the program logic; and
temporarily storing the identifier list for further processing for
selecting from the operand identifiers and
using the selection to generate an operand table, which lists the operands used, with at least one of the respective type and scope of a corresponding access operation,
offering the operand table for further processing for
identifying access to one of the operands used via the operand table, and
defining the access to the one operand within the program logic as a condition for a program interrupt.

2. Method as claimed in claim 1, wherein the control of the technical process is an open loop control.

3. Method as claimed in claim 1, wherein the control of the technical process is a closed loop control.

4. Method as claimed in claim 1, wherein the identifier list is a complete identifier list.

5. The method as claimed in claim 1, wherein said generating comprises:
generating and temporarily storing a partial identifier list with each translation run of the program logic; and
combining all the partial identifier lists into the identifier list.

6. The method as claimed in claim 1, further comprising:
using an adjustable filter element to select defined program identifiers.

7. The method as claimed in claim 6, wherein the defined program identifiers comprise at least one of inputs and outputs of a program, a program sequence, and selected ones of the operands.

8. The method as claimed in claim 1, further comprising:
defining the scope of the access operation within the operand table using a marking tool to mark at least one of a line and a cell of the operand table.

9. The method as claimed in claim 8, further comprising:
defining the type of access operation in addition to said defining of the scope of the access operation.

10. The method as claimed in claim 9, wherein the types of access operation comprise write and read.

11. The method as claimed in claim 9, wherein the types of access are offered for selection with a selection menu, and are defined with a further marking tool, and wherein the type of access is a further condition for the program interrupt.

12. The method as claimed in claim 11, wherein the selection menu comprises at least one of a pop-up menu and a pull-down menu.

13. Programming tool for generating a program interrupt within a program logic with operators and operands for controlling a technical process, comprising:
a temporary storage component for an identifier list of operand identifiers used within the program logic and generated during the translation of the program logic;
a processor component generating an operand table for selected operands, which lists the operands used within the program logic together with at least one of types and scopes of respective access operations, wherein the access operations uniquely correspond to the selected operands in the operand table; and
a generator automatically setting at least one of the access operations as a condition for the program interrupt within the program logic.

14. The programming tool as claimed in claim 13, wherein the control of the technical process comprises at least one of open loop control and closed loop control.

15. The programming tool as claimed in claim 13, further comprising:
a program interrupt component generating a program interrupt instruction in response to the at least one access operation defined by the operand table.

16. The programming tool as claimed in claim 15, further comprising:
an interrupt component interrupting processing of the program logic and operation of a running automation system controlled by the program logic.

17. The programming tool as claimed in claim 15, further comprising:
a program editor automatically called up in response to the program interrupt, and defining a location of the access operation triggering the program interrupt with a marking.

18. The programming tool as claimed in claim 17, wherein the marking is a cursor marking.

19. A method for generating a program interrupt in a program logic configured to control an automated process, comprising:
generating an identifier list containing operand identifiers and respective locations where the operands are respectively used within the program logic;
compiling an operand table with selected ones of the operands and respective access operations to the selected operands; and
defining selected ones of the access operations as respective conditions for the program interrupt.

20. The method according to claim 19, wherein the operand table further includes information defining a scope of access for each of the respective access operations.
